(19) United States
(12) Patent Application Publication
(10) Pub. No.: US 2014/0169003 A1
(43) Pub. Date: Jun. 19, 2014

(54) LED LAMP DEVICE WITH FINS HAVING LONGITUDINAL AND TRANSVERSAL CHANNELS

(71) Applicant: YU-TIEN WANG, New Taipei (TW)

(72) Inventor: YU-TIEN WANG, New Taipei (TW)

(21) Appl. No.: 13/712,989

(22) Filed: Dec. 13, 2012

(51) Int. Cl. F21V 29/00

(52) U.S. Cl. CPC F21V 29/002
USPC 362/373

(57) ABSTRACT

An LED lamp device with fins having longitudinal and transversal channels includes a casing; an upper side of the casing having a cambered shape and a lower side of the casing being formed as a cavity; one end of the cavity being reduced as a neck; a plurality of fins form on an upper surface of the upper side of the casing for increasing heat dissipating areas; the fins being arranged along a longitudinal direction of the casing so as to form with a plurality of longitudinal air channels between the fins; at least one transversal air channel being formed to cut through the fins; by the arrangement of the longitudinal and transversal air paths, air being sufficient filled within the channels between fins; and a copper substrate fixed to the cavity of the casing; a plurality of screw holes being formed on the copper substrate for locking LED lamps.

### FIELD OF THE INVENTION

The present invention relates to heat dissipation of LED lamps, and in particular to an LED lamp device with fins having longitudinal and transversal channels.

### BACKGROUND OF THE INVENTION

There are many kinds of heat dissipating structures for LED lamps. This is because LED dissipates a large amount of heat which needs to be dissipated effectively. In the prior art, the heat dissipating structures for LED lamps of small watts are designed and operated effectively, while this is not suitable for LED lamps of large power consumption. Many designs of heat dissipation aim to dissipate heat of large power LED lamps, but they are ineffective.

### SUMMARY OF THE INVENTION

Accordingly, the object of the present invention is to provide an LED lamp device with fins having longitudinal and transversal channels, wherein by the arrangement of the longitudinal and transversal air paths in fins, heat from the inner side of a casing will be dissipated through the casing to the fins and thus heat is dissipated from the fins along spiral paths. The arrangement of the present invention causes the heat to be dissipated effectively. Generally, by the design of the present invention, temperatures of the casings are descended with a level of 4 to 5 degrees. In general, the heat from the lamp can be effectively dissipated and thus the lifetime of the casing is prolonged.

To achieve above object, the present invention provides an LED lamp device with fins having longitudinal and transversal channels includes a casing; an upper side of the casing having a cambered shape and a lower side of the casing being formed as a cavity; one end of the cavity being reduced as a neck; a plurality of fins being formed on an upper surface of the upper side of the casing for increasing heat dissipating areas; the fins being arranged along a longitudinal direction of the casing so as to form with a plurality of longitudinal air channels between the fins; at least one transversal air channel being formed to cut through the fins; by the arrangement of the longitudinal and transversal air paths, air being sufficient filled within the channels between fins; and a copper substrate fixed to the cavity of the casing; a plurality of screw holes being formed on the copper substrate for locking LED lamps.

### BRIEF DESCRIPTION OF THE DRAWINGS

FIG. 1 is a schematic view of the present invention.

FIG. 2 is another schematic view of the present invention.

FIG. 3 is a further schematic view of the present invention.

FIG. 4 shows the application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

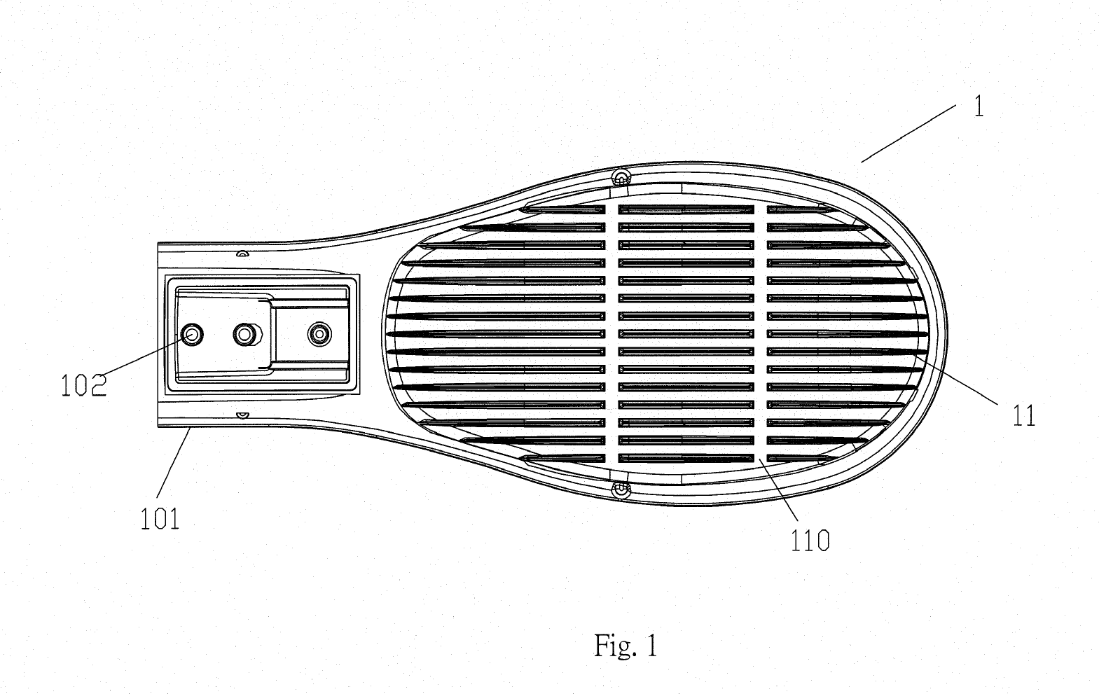

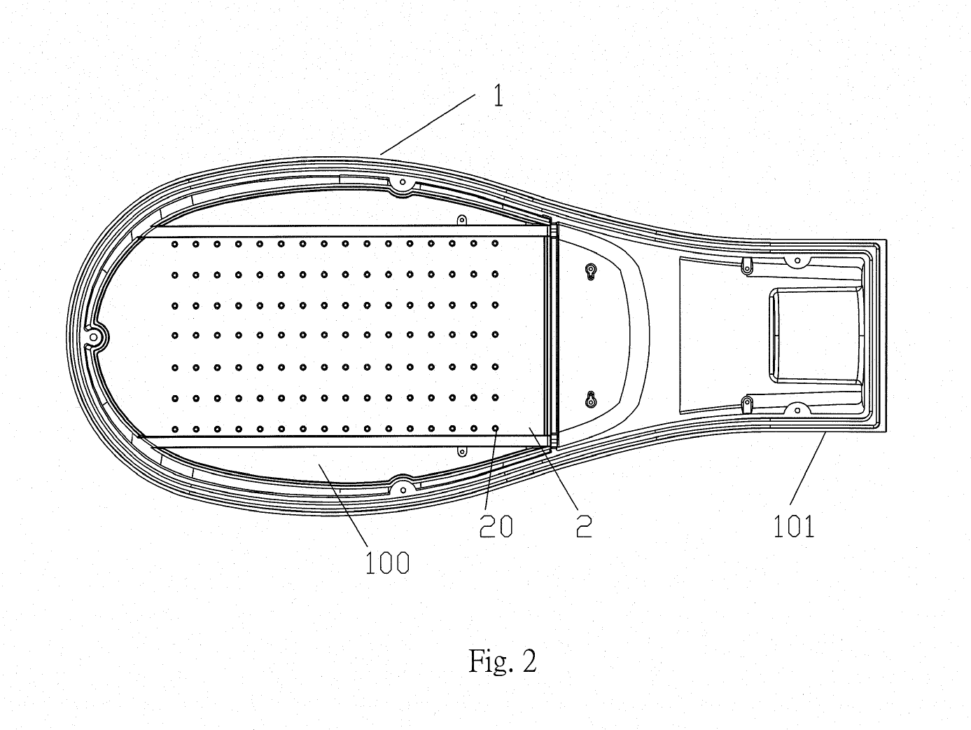

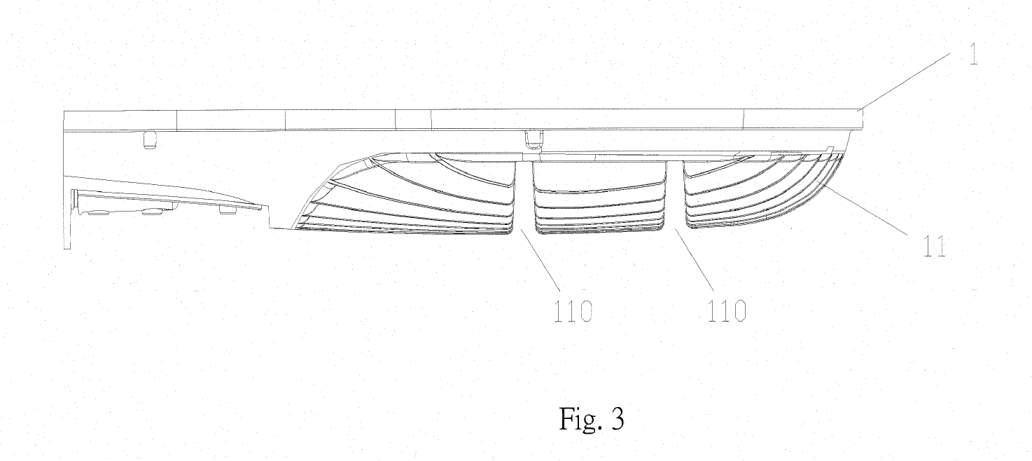

With reference to FIGS. 1 to 3, the structure of the present invention is illustrated. The present invention includes the following elements.

A casing 1 is a three dimensional elliptical half casing. An upper side of the casing 1 has a cambered shape and a lower side of the casing 1 is formed as a cavity 100. One end of the cavity is reduced as a neck 101. The neck 101 has two through holes 102. Screws (not shown) can be used to pass through the two through holes to lock the casing 1 to a retaining frame (such as a lamp frame of a street lamp).

The upper side of the casing 1 is formed with a plurality of fins 11 for increasing heat dissipating areas. The fins are arranged along a longitudinal direction of the casing so as to form with a plurality of longitudinal air channels between the fins. Two transversal air channels 110 are formed to run cross the fins 11. By the arrangement of the longitudinal and transversal air paths, air can be sufficient filled within the paths between fins. The fins 11 serve to dissipate heat outwards. Heat from the inner side of the casing will be dissipated through the casing to the fins and thus is dissipated from the fins along spiral paths. The arrangement of the present invention causes the heat to be dissipated effectively. Generally, by the design of the present invention, temperatures of the casings 1 are descended with a level of 4 to 5 degrees. In general, the heat from the lamp can be effectively dissipated and thus the lifetime of the casing is prolonged.

A copper substrate 2 is fixed to the cavity of the casing 1. A plurality of screw holes are formed on the copper substrate 2 for locking a plurality of lamp strips. Each lamp strip is arranged with a plurality of LED lamps. The number of the strips is based on the requirement of illumination. The strips are arranged transversally so as to increase the illumination of the lamp device of the present invention.

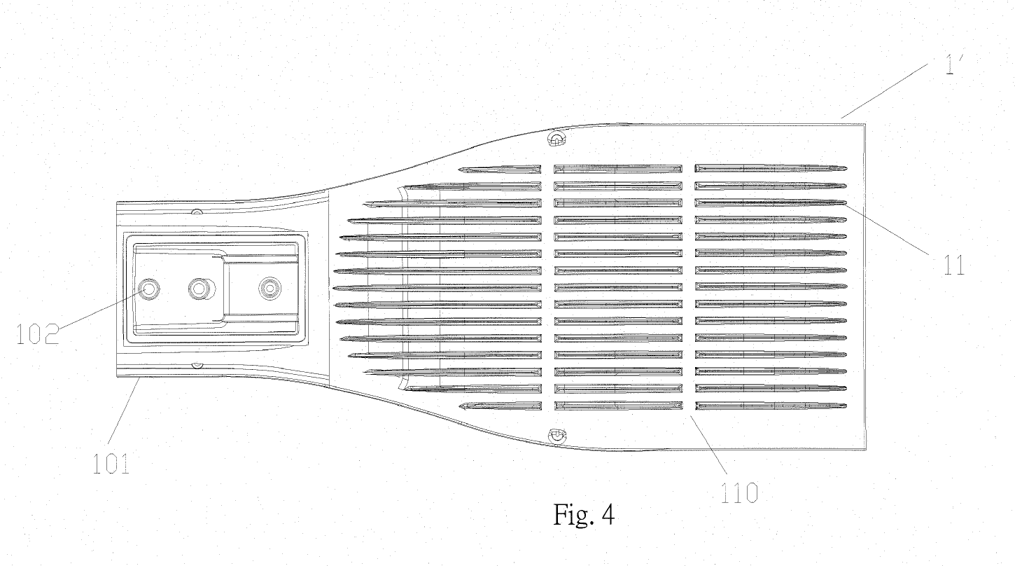

With reference to FIG. 4, the second embodiment of the present invention is illustrated. In the present invention, those identical to the formed embodiment illustrated in FIGS. 1 to 3 are shown by the same numerals.

A casing 1′ is a rectangular casing. An upper side of the casing 1′ has a cambered shape and a lower side of the casing 1 is formed as a cavity 100. One end of the cavity is reduced as a neck 101. The neck 101 has two through holes 102. Screws (not shown) can be used to pass through the two through holes to lock the casing 1 to a retaining frame (such as a lamp frame of a street lamp).

The upper side of the casing 1 is formed with a plurality of fins 11 for increasing heat dissipating areas. The fins are arranged along a longitudinal direction of the casing so as to form with a plurality of longitudinal air channels between fins. Two transversal air channels 110 are formed to run cross the fins 11. By the arrangement of the longitudinal and transversal air channels, air can be sufficient filled within the paths between fins. The fins 11 serve to dissipate heat outwards. Heat from the inner side of the casing will be dissipated through the casing to the fins and thus is dissipated from the fins along spiral paths. The arrangement of the present invention causes the heat to be dissipated effectively. Generally, by the design of the present invention, temperatures of the casings 1 are descended with a level of 4 to 5 degrees. In general, the heat from the lamp can be effectively dissipated and thus the lifetime of the casing is prolonged.

A copper substrate 2 is fixed to the cavity of the casing 1. A plurality of screw holes are formed on the copper substrate 2 for locking a plurality of lamp strips. The lamp strips are arranged with a plurality of LED lamps. The number of the strips is based on the requirement of illumination. The strips are arranged transversally so as to increase the illumination of the lamp device of the present invention.

However, in the present invention, the shape of casing is not confined to above mentioned elliptical form and rectangular form. Other shapes, such as oblong shape, round shape and others are also within the scope of the present invention.

In the present invention, by the arrangement of the longitudinal and transversal air paths, heat from the inner side of the casing will be dissipated through the casing to the fins and thus is dissipated from the fins along spiral paths. The arrangement of the present invention causes the heat to be dissipated effectively. Generally, by the design of the present invention, temperatures of the casings are descended with a level of 4 to 5 degrees. In general, the heat from the lamp can be effectively dissipated and thus the lifetime of the casing is prolonged. In general, frequency bands of lights emitted from LED lamps are narrow and thus the lamps will not attract insects to stop on the lamp to affect the illumination. Moreover, LED lamps only consumes a small amount of the prior art lamps. Integrally, a large amount of power is saved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An LED lamp device with fins having longitudinal and transversal channels, comprising:
a casing; an upper side of the casing having a cambered shape and a lower side of the casing being formed as a cavity; one end of the cavity being reduced as a neck;
a plurality of fins form on an upper surface of the upper side of the casing for increasing heat dissipating areas; the fins being arranged along a longitudinal direction of the casing so as to form with a plurality of longitudinal air channels between the fins; at least one transversal air channel being formed to cut through the fins; by the arrangement of the longitudinal and transversal air paths, air being sufficient filled within the channels between fins; and
a copper substrate fixed to the cavity of the casing; a plurality of screw holes being formed on the copper substrate for locking LED lamps.

2. The LED lamp device with fins having longitudinal and transversal channels as claimed in claim 1, wherein the casing is a three dimensional half elliptical casing.

3. The LED lamp device with fins having longitudinal and transversal channels as claimed in claim 1, wherein the casing is a rectangular casing.

4. The LED lamp device with fins having longitudinal and transversal channels as claimed in claim 1, wherein there are two transversal air channels.

5. The LED lamp device with fins having longitudinal and transversal channels as claimed in claim 1, wherein the fins cause a temperature reduction of 4 to 5 degrees as LED lamps dissipate heat.

6. The LED lamp device with fins having longitudinal and transversal channels as claimed in claim 1, wherein a plurality of lamp strips are installed to the copper substrate; the lamp strips are arranged with plurality of LED lamps.

7. The LED lamp device with fins having longitudinal and transversal channels as claimed in claim 6, wherein the strips are arranged transversally so as to increase the illumination of the lamp device.

8. The LED lamp device with fins having longitudinal and transversal channels as claimed in claim 1, wherein the neck has two through holes; and screws are used to pass through the two through holes to lock the casing to a retaining frame.
